(19) United States
(12) Patent Application Publication
(10) Pub. No.: US 2026/0164350 A1
(43) Pub. Date: Jun. 11, 2026

(54) POWER SAVING FOR RELAXED MEASUREMENT IN MULTIPLE-SUBSCRIBER IDENTITY MODULE (MSIM) MODE

(71) Applicant: QUALCOMM Incorporated, San Diego, CA (US)

(72) Inventors: Chunxia LI, Beijing (CN); Matthew Heng ZHANG, Shanghai (CN); Yuyu YAN, Beijing (CN); Hua XU, Shanghai (CN); Liang ZHU, Shanghai (CN)

(21) Appl. No.: 18/707,379

(22) PCT Filed: Jan. 11, 2022
(86) PCT No.: PCT/CN2022/071223

§ 371 Date: May 3, 2024

(51) Int. Cl. H04W 52/02

(52) U.S. Cl. CPC H04W 52/0216

(57) ABSTRACT

In certain aspects, a method of operating a wireless device is provided. The wireless device includes a first subscriber identity module (SIM) corresponding to a first subscriber, a second SIM corresponding to a second subscriber, and a transceiver shared by the first subscriber and the second subscriber. The method includes granting the second subscriber ownership of the transceiver for a time duration, during the time duration, receiving one or more signals from one or more cells via the transceiver, during the time duration, measuring the one or more signals to obtain one or more measurements, and, during the time duration, evaluating the one or more measurements for at least one of a handover of the first subscriber, a frequency reselection for the first subscriber, and a radio access technology (RAT) switch for the first subscriber. In certain aspects, the wireless device may further include one or more additional SIMs.

### BACKGROUND

### Field

Aspects of the present disclosure relate generally to wireless communications, and more particularly, to multiple-subscriber identity module (MSIM) wireless devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform-spread-OFDM (DFT-S-OFDM). A wireless multiple-access communications system may include multiple base stations or network access nodes, each simultaneously supporting communication for multiple wireless devices, which may be otherwise known as user equipment (UE).

A UE (e.g., smart phone, laptop, and the like) may include multiple subscriber identity modules (SIMs) in which each SIM is associated with a different subscriber. Each subscriber may be assigned to a different account and/or telephone number. In a UE that includes one transceiver for multiple subscribers, one of the subscribers may actively receive and/or transmit signals via the transceiver at a time.

### SUMMARY

The following presents a simplified summary of one or more implementations in order to provide a basic understanding of such implementations. This summary is not an extensive overview of all contemplated implementations and is intended to neither identify key or critical elements of all implementations nor delineate the scope of any or all implementations. Its sole purpose is to present some concepts of one or more implementations in a simplified form as a prelude to the more detailed description that is presented later.

A first aspect relates to an apparatus for wireless communication. The apparatus includes a first subscriber identity module (SIM) corresponding to a first subscriber, a second SIM corresponding to a second subscriber, a transceiver that is shared by the first subscriber and the second subscriber, a processor, and a memory coupled with the processor. The apparatus further includes instructions stored in the memory and executable by the processor to cause the apparatus to grant the second subscriber ownership of the transceiver for a time duration, during the time duration, receive one or more signals from one or more cells via the transceiver, during the time duration, measure the one or more signals to obtain one or more measurements, and, during the time duration, evaluate the one or more measurements for at least one of a handover of the first subscriber, a frequency reselection for the first subscriber, and a radio access technology (RAT) switch for the first subscriber.

A second aspect relates to a method of operating a wireless device. The wireless device includes a first subscriber identity module (SIM) corresponding to a first subscriber, a second SIM corresponding to a second subscriber, and a transceiver shared by the first subscriber and the second subscriber. The method includes granting the second subscriber ownership of the transceiver for a time duration, during the time duration, receiving one or more signals from one or more cells via the transceiver, during the time duration, measuring the one or more signals to obtain one or more measurements, and, during the time duration, evaluating the one or more measurements for at least one of a handover of the first subscriber, a frequency reselection for the first subscriber, and a radio access technology (RAT) switch for the first subscriber.

### BRIEF DESCRIPTION OF THE DRAWINGS

FIG. 1 shows an example of a wireless communications system according to certain aspects of the present disclosure.

FIG. 2 shows an example of a multiple-subscriber identity module (MSIM) UE according to certain aspects of the present disclosure.

FIG. 3 is a timeline illustrating an example in which a UE is unable to perform measurements for a first subscriber while a second subscriber has ownership of a transceiver on the UE according to certain aspects of the present disclosure.

FIG. 4 is a timeline illustrating an example in which a UE performs measurements for the first subscriber while the second subscriber has ownership of the transceiver according to certain aspects of the present disclosure.

FIG. 5 shows an example of a memory including measurements for the first subscriber and the second subscriber according to certain aspects of the present disclosure.

FIG. 6 is a timeline illustrating an example in which a UE performs measurements for the second subscriber while the first subscriber has ownership of the transceiver according to certain aspects of the present disclosure.

FIG. 7 shows an example of a MSIM UE including at least three SIMs according to certain aspects of the present disclosure.

FIG. 8 illustrates an exemplary method for operating a wireless device according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

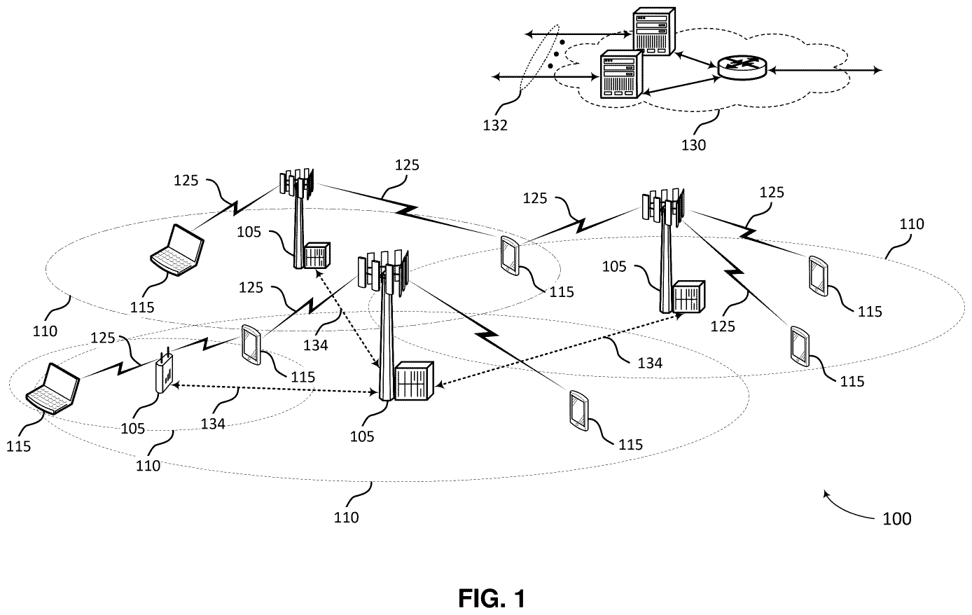

FIG. 1 shows an example of a wireless communications system 100 in accordance with aspects of the present disclosure. The wireless communications system 100 includes base stations 105, UEs 115, and a core network 130. In some examples, the wireless communications system 100 may be a Long-Term Evolution (LTE) network, an LTE-Advanced (LTE-A) network, an LTE-A Pro network, a New Radio (NR) network, or a combination thereof.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. Wireless communications system 100 may include base stations 105 of different types (e.g., macro or small cellbase stations). The UEs 115 described herein may be able to communicate with various types of base stations 105 and network equipment including macro eNBs, small celleNBs, gNBs, relay base stations, and the like.

Each base station 105 may be associated with a respective geographic coverage area 110 in which communications with various UEs 115 is supported. Each base station 105 may provide communication coverage for the respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105 and downlink transmissions from a base station 105 to a UE 115. Downlink transmissions may also be called forward link transmissions while uplink transmissions may also be called reverse link transmissions.

Each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. The wireless communications system 100 may include, for example, a heterogeneous LTE/LTE-A/LTE-A Pro or NR network in which different types of base stations 105 provide coverage for various geographic coverage areas 110.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Base stations 105 may communicate with the core network 130 and with one another. For example, base stations 105 may interface with the core network 130 through backhaul links 132 (e.g., via an S1 interface or another interface). Base stations 105 may communicate with one another over backhaul links 134 (e.g., via an X2 interface or another interface) either directly (e.g., directly between base stations 105) or indirectly (e.g., via the core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

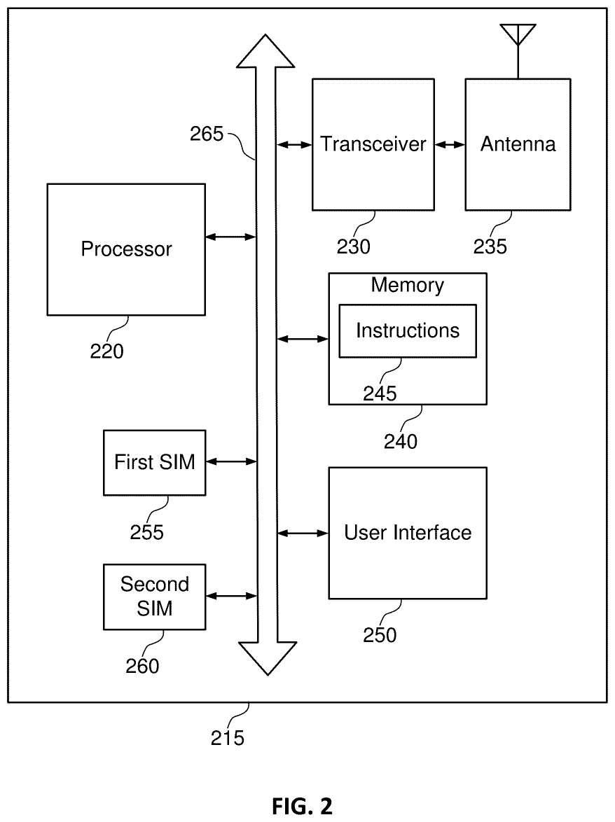

FIG. 2 illustrates an example of a multiple-subscriber identity module (MSIM) UE 215 that may be used in the exemplary wireless communications system 100 according to aspects of the present disclosure. The UE 215 may correspond to any one of the exemplary UEs 115 shown in FIG. 1. As used herein, a “MSIM UE” is a UE (also referred to as a wireless device) including two or more SIMs.

In the example in FIG. 2, the UE 215 includes a processor 220, a memory 240, a transceiver 230, one or more antennas 235, a user interface 250, a first SIM 255, and a second SIM 260. These components may be in electronic communication via one or more buses 265. Although two SIMs (i.e., the first SIM 255 and the second SIM 260) are shown in FIG. 2, it is to be appreciated that, in some implementations, the UE 215 may include one or more additional SIMs, as discussed further below.

The memory 240 may store instructions 245 that are executable by the processor 220 to cause the UE 215 to perform one or more of the operations described herein. The processor 220 may include a general-purpose processor, a baseband processor, a modem, a digital signal processor (DSP), a central processing unit (CPU), a microcontroller, an application specific integrated circuit (ASIC), a field programmable gate array (FPGA), a programmable logic device, a discrete gate or transistor logic component, a discrete hardware component, or any combination thereof. The memory 240 may include, by way of example, random access memory (RAM), flash memory, read only memory (ROM), programmable read only memory (PROM), erasable programmable read only memory (EPROM), electrically erasable programmable read only memory (EEPROM), registers, magnetic disks, optical disks, hard drives, or any other suitable storage medium, or any combination thereof.

The transceiver 230 is configured to communicate with one or more base stations (e.g., one or more of the base stations 105) via the one or more antennas 235. More particularly, the transceiver 230 is configured to transmit signals to the one or more base stations and receive signals from the one or more base stations via the one or more antennas 235, as discussed further below.

The user interface 250 may be configured to receive data from a user (e.g., via keypad, mouse, touchscreen, etc.) and provide the data to the processor 220. The user interface 250 may also be configured to output data from the processor 220 to the user (e.g., via a display, a speaker, etc.).

In certain aspects, the first SIM 255 includes memory (e.g., in a removable integrated circuit card) that stores an International Mobile Subscriber Identity (IMSI), user account information, authentication information, and/or other information used to identify and/or authenticate a first subscriber with a network (e.g., wireless communications system 100). The first subscriber may have a subscription for one or more services (e.g., data services, voice services, IMS services, etc.) on the network.

The second SIM 260 includes memory (e.g., in a removable integrated circuit card) that stores an International Mobile Subscriber Identity (IMSI), user account information, authentication information, and/or other information used to identify and/or authenticate a second subscriber with a network (e.g., wireless communications system 100). The second subscriber may have a subscription for one or more services (e.g., data services, voice services, IMS services, etc.) on the network. Although two SIMs (i.e., the first SIM 225 and the second SIM 260) are shown in FIG. 2, it is to be appreciated that the UE 215 may include more than two SIMs in some implementations.

The first and second subscribers may have subscriptions with the same network carrier or different network carriers. Also, the first and second subscribers may have subscriptions for the same services and/or different services.

In certain aspects, the first subscriber and the second subscriber may share the transceiver 230 in an MSIM mode, in which one of the subscribers may actively receive and/or transmit signals via the transceiver 230 at a time while the other subscriber may be put on standby. The MSIM mode may include a multiple SIM multiple standby (MSMS) mode, a multiple SIM multiple active (MSMA) mode, or another type of MSIM mode. For an example where the UE 215 only employs two SIMs in the MSIM mode, the MSMS mode may also be referred to as a dual SIM dual standby (DSDS) mode and the MSMA mode may also be referred to as a dual SIM dual active (DSDA) mode. Thus, it is to be appreciated that the MSIM mode may employ two SIMs (e.g., the first SIM 255 and the second SIM 260) or more than two SIMs (e.g., the first SIM 255, the second SIM 260, and one or more additional SIMs).

In these aspects, the UE 215 may manage access to the transceiver 230 by the first subscriber and the second subscriber. For an example in which the first subscriber has a first subscription for data services and the second subscriber has a second subscription for voice services, the UE 215 may allow access to the transceiver 230 for data services and voice calls one at time. For example, when the second subscriber receives a voice call from a network, the UE 215 may establish a voice call session with the network for the second subscriber using the transceiver 230. During the voice call, the first subscriber may not have access to the transceiver 230 for receiving or transmitting data. In this example, the UE 215 may give voice calls priority over data transfers in which the UE 215 gives the second subscriber access to the transceiver 230 when there is an incoming voice call. It is to be appreciated that the present disclosure is not limited to this example, and that the UE 215 may manage access to the transceiver 230 by the first subscriber and the second subscriber for other use cases in the MSIM mode using any one of a variety of procedures and/or priorities.

In certain aspects, the UE 215 may perform measurements for a subscriber (e.g., the first subscriber corresponding to the first SIM 255 or the second subscriber corresponding to the second SIM 260). For example, the UE 215 may perform measurements on one or more signals (e.g., reference signals) received by the transceiver 230 from one or more base stations, and report the measurements to a network. Based on the measurements, the network may make a handover decision for the subscriber and/or assign the subscriber to a frequency (e.g., center frequency), as discussed further below. The UE 215 may report the measurements to the network periodically and/or when certain events occur (e.g., one or more measurements satisfy certain criteria, a network requests measurements, etc.), as discussed further below. As used herein, it is to be understood that the term “criteria” may be one criterion or more than one criterion.

In certain aspects, the processor 220 may perform any one or more of the following types of measurements: intra-frequency measurements, inter-frequency measurements, and inter-radio access technology (IRAT) measurements. Each of these measurements are discussed below according to certain aspects. However, it is to be appreciated that the present disclosure is not limited to theses examples, and that the UE 215 may perform other types of measurements on signals received by the transceiver 230.

For an intra-frequency measurement, the UE 215 measures a signal (e.g., reference signal) received from a base station at a frequency (e.g., center frequency) that is currently assigned to a subscriber (e.g., the first subscriber or the second subscriber) for wireless communication. The UE 215 may receive the signal via the transceiver 230 from a serving cell or a neighboring cell. The serving cell may be the cell currently assigned to the subscriber for providing the subscriber with services (e.g., data services, voice services, IMS services, etc.). The neighboring cell may be a cell that is within range of the UE 215, making the cell a candidate for a potential handover of the subscriber. Each cell may correspond to a base station (e.g., any one of base stations 105), a transceiver of a base station, or a coverage area a base station (e.g., any one of coverage areas 110).

The intra-frequency measurement may include any one or more of the following measurements: cell selection RX level value (Srxlev), signal-to-noise and interference ratio (SINR), reference signal received power (RSRP), reference signal received quality (RSRQ), received signal strength indicator (RSSI), and/or one or more other measurements for measuring signal strength and/or quality.

In one example, the UE 215 may perform a first intra-frequency measurement on a signal (e.g., reference signal) received from the serving cell and perform a second intra-frequency measurement on a signal (e.g., reference signal) received from a neighboring cell. In this example, the UE 215 may report the infra-frequency measurements to the network via the transceiver 230, and the network may make a handover decision for the subscriber based on the measurements, as discussed further below. It is to be appreciated that the present disclosure is not limited to this example, and that intra-frequency measurements may be used to make other decisions.

For an inter-frequency measurement, the UE 215 measures a signal (e.g., reference signal) received from a cell at a frequency (e.g., center frequency) that is different from the frequency currently assigned to the subscriber for wireless communication. The UE 215 may receive the signal via the transceiver 230 from the serving cell or a neighboring cell. The inter-frequency measurement may include any one or more of the following measurements: Srxlev, SINR, RSRP, RSRQ, RSSI, and/or one or more other measurements for measuring signal strength and/or quality.

In one example, the subscriber may be currently assigned to a first frequency (e.g., center frequency). In this example, the UE 215 may perform an inter-frequency measurement on a signal (e.g., reference signal) at a second frequency (e.g., center frequency). The signal may be received via the transceiver 230 from the serving cell or a neighboring cell. In this example, the UE 215 may need to retune the transceiver 230 to the second frequency to perform the inter-frequency measurement. This may cause a measurement gap during which time the UE 215 suspends communication at the first frequency to perform the inter-frequency measurement. In this example, the UE 215 may report the inter-frequency measurement to the network via the transceiver 230, and the network may determine whether to reassign the subscriber to the second frequency (i.e., select the second frequency for the subscriber) based on the inter-frequency measurement, as discussed further below. If the inter-frequency measurement is performed on a signal from a neighboring cell, then the network may also decide whether to hand over the subscriber to the neighboring cell.

For an IRAT measurement, the UE 215 measures a signal (e.g., reference signal) received from a cell using a radio access technology (RAT) that is different from the RAT currently being used by the subscriber for wireless communication. The UE 215 may receive the signal using the transceiver 230. The IRAT measurement may include any one or more of the following measurements: Srxlev, SINR, RSRP, RSRQ, RSSI, and/or one or more other measurements for measuring signal strength and/or quality. Examples of RATs include 2G, 3G, GSM, CDMA (e.g., WCDMA), LTE, NR, etc.

In one example, the subscriber may be currently using a first RAT for wireless communication. In this example, the UE 215 may perform an IRAT measurement on a signal (e.g., reference signal) received from a cell using a second RAT. In this example, the transceiver 230 is a multiple-RAT transceiver that supports multiple RATs including the first RAT and the second RAT. The first RAT and the second RAT may be different ones of 2G, 3G, GSM, CDMA, LTE, NR, etc. In this example, the UE 215 may report the IRAT measurement to a network via the transceiver 230, and the network may determine whether to switch (i.e., change) the subscriber to the second RAT based on the IRAT measurement, as discussed further below.

In certain aspects, the UE 215 may perform intra-frequency measurements, inter-frequency measurements, and/or IRAT measurements for each one of the first subscriber and the second subscriber to make handover decisions, frequency assignment decisions, and/or other decisions for each one of the first subscriber and the second subscriber.

As discussed above, the first subscriber and the second subscriber may share the transceiver 230 in the MSIM mode, in which one of the subscribers may actively receive and/or transmit signals via the transceiver 230 at a time while the other subscriber may be put on standby.

A problem may arise in the MSIM mode when one of the subscribers has access to the transceiver 230 for a long time duration while the other one of the subscribers is in standby. This is because the UE 215 is unable to perform measurements (e.g., intra-frequency measurements, inter-frequency measurements, and/or IRAT measurements) for the subscriber in standby for a long time. This can result in an out of service (OOS) condition and/or a radio link failure (RLF). For example, while the UE is unable to perform measurements for the subscriber in standby, the UE 215 may move out of range of the serving cell. In this example, the UE 215 is unable to perform the measurements needed to hand over the subscriber in standby to the neighboring cell before the UE 215 moves out of range of the serving cell, which can result in an OOS condition and/or RLF.

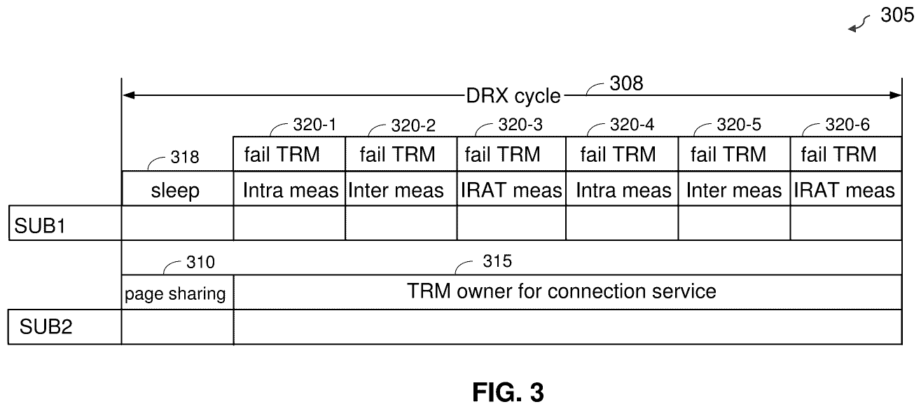

As example of this problem is illustrated in FIG. 3 according to certain aspects. FIG. 3 shows an example of a timeline 305 for the first subscriber (labeled “SUB1”) and the second subscriber (labeled “SUB2”) during a time duration 308 (e.g., discontinuous reception (DRX) cycle). As discussed above, the first subscriber corresponds to the first SIM 255 and the second subscriber corresponds to the second SIM 260.

In this example, the first subscriber and the second subscriber share the transceiver 230. The transceiver 230 provides a transmit receive module (TRM) resource on the UE 215 for the first subscriber and the second subscriber since the transceiver 230 transmits and receives signals for the first subscriber and the second subscriber. In this example, the first subscriber and the second subscriber share the TRM resource (i.e., transceiver 230) in which the UE 215 grants (i.e., gives) one of the first subscriber and the second subscriber ownership of the TRM resource at a time for transmitting and receiving signals. The subscriber with ownership of the TRM resource has access to the transceiver 230 for transmitting signals to and/or receiving signals from a network (e.g., wireless communications system 100).

In the example shown in FIG. 3, the second subscriber has ownership of the TRM resource 315 during the time duration 308. For example, the second subscriber may receive a voice call from the network, and the UE 215 may grant ownership of the TRM resource (i.e., access to the transceiver 230) to the second subscriber to receive the voice call. During the time duration 308, the first subscriber does not have access to the TRM resource.

In the example in FIG. 3, the second subscriber receives paging messages via the transceiver 230 for the first subscriber and/or the second subscriber from a cell (e.g., the serving cell of the second subscriber) during a page sharing duration 310. The UE 215 may forward a paging message for the first subscriber to the first subscriber. The paging message may include information of an incoming call and/or data transfer for the first subscriber and/or other paging information. The first subscriber and the second subscriber may share the same serving cell in this example.

In this example, the first subscriber does not have access to the TRM resource (i.e., transceiver 230) during the time duration 308 since the second subscriber has ownership of the TRM resource. During the time duration 308, the first subscriber is initially in sleep mode 318. The first subscriber then requests the TRM resource (i.e., access to the transceiver 230) for the UE 215 to perform measurements (e.g., intra-frequency measurements, inter-frequency measurements, and/or IRAT measurements) for the first subscriber. However, since the second subscriber has ownership of the TRM resource, the TRM requests fail 320-1 to 320-6. In this example, the first subscriber may unsuccessfully request the TRM resource multiple times instead of reentering sleep mode, which consumes power. Further, since the first subscriber is unable to requests the TRM resource for a long time, the first subscriber is unable to obtain measurements needed for handover and/or frequency reselection, which can result in an OOS condition and/or RLF.

To address the above, in certain aspects, the UE 215 performs measurements (e.g., intra-frequency measurements, inter-frequency measurements, and/or IRAT measurements) for both the first subscriber and the second subscriber when one of the subscribers has ownership of the TRM resource (i.e., access to the transceiver) and the other subscriber is in standby (e.g., in MSMS mode). For the example where the second subscriber has ownership of the TRM resource and the first subscriber is in standby, this allows the UE to perform the measurements needed to make handover decisions and/or frequency reselection decisions for the first subscriber while the second subscriber has ownership of the TRM resource (e.g., for an active service connection). These measurements may be evaluated for handover and/or frequency reselection of the first subscriber, substantially reducing the likelihood of an OOS condition and/or RLF compared with the current approach illustrated in FIG. 3. Also, because the UE 215 performs measurements for the first subscriber while the second subscriber has ownership of the TRM resource, the first subscriber may remain in the sleep mode (e.g., for an entire DRX cycle), which reduces power consumption. The above aspects and additional aspects of the present disclosure are discussed further below.

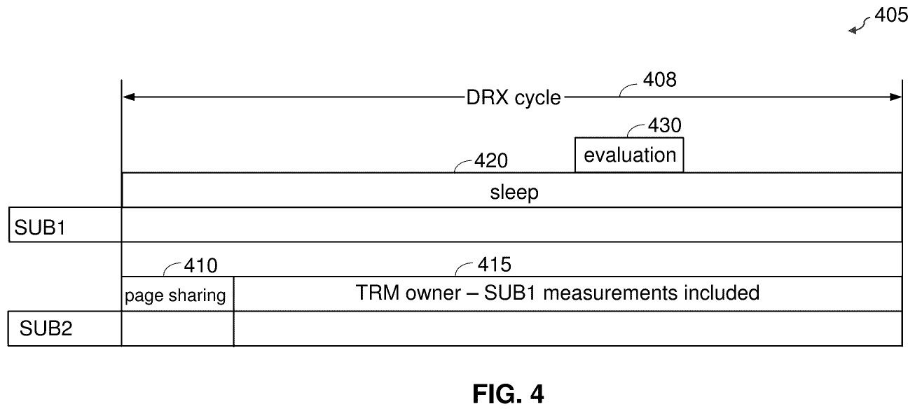

Exemplary aspects of the present disclosure will now be described with reference to FIG. 4. FIG. 4 shows an example of a timeline 405 for the first subscriber (labeled “SUB1”) and the second subscriber (labeled “SUB2”) during a time duration 408. As discussed above, the first subscriber corresponds to the first SIM 255 and the second subscriber corresponds to the second SIM 260. In the example in FIG. 4, the time duration 408 includes a discontinuous reception (DRX) cycle. However, it is to be appreciated that the present disclosure is not limited to this example. In some examples, the DRX cycle may have a length of a few hundred milliseconds or a length greater than one second.

As discussed above, the first subscriber and the second subscriber share the transceiver 230, in which the transceiver 230 provides the TRM resource on the UE 215 for the first subscriber and the second subscriber. In this example, the first subscriber and the second subscriber share the TRM resource (i.e., transceiver 230) in which the UE 215 grants one of the first subscriber and the second subscriber ownership of the TRM resource at a time. For example, the UE 215 may grant one of the first subscriber and the second subscriber ownership of the TRM resource at a time for an active service connection with a network (e.g., wireless communications system 100). As used herein, a “service connection” is a wireless connection for receiving one or more services (e.g., data services, voice services, IMS services, etc.) from the network.

In the example shown in FIG. 4, the second subscriber has ownership of the TRM resource during the time duration 408 (e.g., DRX cycle). For example, the second subscriber may receive a voice call from the network, and the UE 215 may grant ownership of the TRM resource (i.e., access to the transceiver 230) to the second subscriber to receive the voice call. However, it is to be appreciated that the present disclosure is not limited to this example, and that the UE 215 may grant the second subscriber ownership of the TRM resource during the time duration 408 in another use case. During the time duration 408 (e.g., DRX cycle), the first subscriber does not have access to the TRM resource in this example.

In the example in FIG. 4, the second subscriber may receive paging messages via the transceiver 230 for the first subscriber and/or the second subscriber from a cell (e.g., the serving cell of the second subscriber) during a page sharing duration 410. In this example, the page sharing duration 410 is located at the beginning of the time duration 408. The UE 215 may forward a paging message for the first subscriber to the first subscriber. The paging message may include information of an incoming call and/or data transfer for the first subscriber and/or other paging information. If the UE 215 does not receive a paging message for the first subscriber during the page sharing duration 410, then the first subscriber may stay in sleep mode for the time duration 408 (e.g., DRX cycle). In some cases, the first subscriber may stay in sleep mode for the time duration 408 even if a paging message is received for the first subscriber. This may occur, for example, if the second subscriber needs the TRM resource for a service (e.g., voice call) having a higher priority than a service (e.g., data transfer) indicated by the paging message for the first subscriber.

In the example in FIG. 4, the second subscriber has ownership of the TRM resource 415 during the time duration 408 (e.g., DRX cycle). For example, the second subscriber may have ownership of the TRM resource 415 for a service connection with the network (e.g., a connection for data service, voice call service, etc.). For the example of a data service, the second subscriber may receive data from and/or transmit data to the network via the transceiver 230. For the example of a voice call service, the second subscriber may make or receive a voice call.

While the second subscriber has ownership of the TRM resource, the UE 215 performs measurements (e.g., intra-frequency measurements, inter-frequency measurements, and/or IRAT measurements) for the second subscriber as well as the first subscriber. This allows the first subscriber to remain in the sleep mode 420 for the time duration 408 while still obtaining the measurements needed to make handover decisions and/or frequency reselection decisions for the first subscriber. In other words, the first subscriber does not need to come out of the sleep mode to perform the measurements, which reduces power consumption. Also, the measurements obtained for the first subscriber may be evaluated by the processor 220 for handover and/or frequency reselection of the first subscriber, substantially reducing the likelihood of an OOS condition and/or RLF due to a long time of no measurements for the subscriber (as is the case illustrated in FIG. 3). The evaluation may be performed while the first subscriber is in the sleep mode, allowing the first subscriber to remain in the sleep mode longer for lower power consumption.

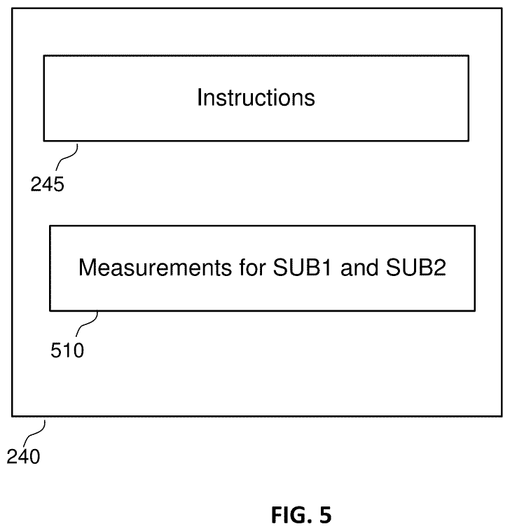

In one example, the measurements for the first subscriber and the second subscriber may be stored in a common (i.e., shared) memory on the UE 215. In this regard, FIG. 5 shows an example in which the measurements 510 for the first subscriber and the second subscriber are stored in the memory 240, which is common to the first subscriber and the second subscriber. It is to be appreciated that the measurements 510 for the first subscriber and the second subscriber may overlap (i.e., one or more of the measurements may be used for making a handover decision and/or frequency reselection for either of the subscribers).

The common memory (e.g., memory 240) may also store measurement instructions indicating the measurements (e.g., intra-frequency measurements and/or inter-frequency measurements) that need to be performed for the first subscriber and/or the second subscriber. For the example of inter-frequency measurements, the measurement instructions may indicate the frequencies at which the inter-frequency measurements are to be made for the first subscriber and/or the second subscriber. In one example, the UE 215 may receive the measurement instructions for the first subscriber and/or the second subscriber from the network via the transceiver 230 and store the received measurement instructions in the common memory. In this example, when the UE 215 performs the measurements during the time duration 408, the UE 215 retrieves the measurement instructions for the first subscriber and/or the second subscriber from the common memory, and performs the measurements based on the measurement instructions (e.g., performs inter-frequency measurements at the frequencies indicated in the measurements instructions). The measurements instructions in the common memory helps the UE 215 determine which measurements to perform for the first subscriber while the first subscriber is in the sleep mode. For the example of inter-frequency measurements, the measurement instructions in the common memory may indicate at which frequencies the UE 215 is to perform the inter-frequency measurements for the first subscriber while the first subscriber is in the sleep mode.

In certain aspects, the measurements for each of the first subscriber and the second subscriber may include measurements (intra-frequency measurements and/or inter-frequency measurements) of signals received from the serving cell and/or measurements (intra-frequency measurements and/or inter-frequency measurements) of signals received from one or more neighboring cells. The processor 220 may evaluate one or more of the measurements for each of the subscribers to determine whether to handover the subscriber to one of the neighboring cells, as discussed further below. The processor 220 may retrieve the measurements from the common memory (e.g., memory 240) to perform the evaluation.

In certain aspects, the measurements for each of the first subscriber and the second subscriber may include inter-frequency measurements of signals received at one or more different frequencies (e.g., center frequencies) from the serving cell and/or one or more neighboring cells. For example, the inter-frequency measurements may be stored in a frequency table (i.e., list) in the memory 240 according to frequency. The processor 220 may evaluate one or more of the inter-frequency measurements for each of the subscribers to determine whether to reselect a new frequency for the subscriber, as discussed further below. As used herein, “a new frequency” is a frequency that is different from the frequency currently assigned to a subscriber for wireless communication (e.g., service connection).

In certain aspects, the measurements for each of the first subscriber and the second subscriber may include IRAT measurements of signals received from the serving cell and/or one or more neighboring cells. The processor 220 may evaluate one or more of the IRAT measurements for each of the subscribers to determine whether to switch the subscriber to a new RAT, as discussed further below. As used herein, “a new RAT” is a RAT that is different from the RAT current used by a subscriber for wireless communication (e.g., service connection).

As discussed above, the processor 220 may evaluate 430 the measurements for the first subscriber for a potential handover, frequency reselection, and/or RAT switch during the time duration 408. The processor 220 may perform the evaluation while the first subscriber is in the sleep mode, allowing the first subscriber to remain in the sleep mode longer. As discussed above, the processor 220 may retrieve the measurements for the evaluation from the common memory (e.g., memory 240).

In certain aspects, the evaluation for a potential handover of the first subscriber may include determining whether one or more measurements for the first subscriber meet (i.e., satisfy) a criteria for handover. If the criteria for handover is met, then the processor 220 may send a report of the one or more measurements to the network via the transceiver 230. The report may indicate that the criteria for handover is met (i.e., satisfied). In response, the network may initiate handover of the first subscriber to a neighboring cell. In this case, the first subscriber may be taken out of the sleep mode to complete the handover procedure. If the criteria is not met, then the first subscriber may remain in the sleep mode.

In one example, the evaluation for handover may include comparing a measurement (e.g., intra-frequency measurement) of a signal from the serving cell of the first subscriber with a threshold. The measurement may include Srxlev, SINR, RSRP, RSRQ, and/or another measurement of signal strength or quality. In this example, the criteria for handover is met when the measurement is below the threshold. In this case, the signal from the serving cell may be weak when the measurement is below the threshold, indicating the first subscriber needs to be handed over to a neighboring cell.

In another example, the evaluation for handover may include comparing a first measurement (e.g., intra-frequency measurement) of a signal from the serving cell of the first subscriber with a first threshold and comparing a second measurement of a signal from a neighboring cell with a second threshold. Each of the measurements may include Srxlev, SINR, RSRP, RSRQ, and/or another measurement of signal strength or quality. In this example, the criteria for handover is met when the first measurement is below the first threshold and the second measurement is above the second threshold.

In another example, the evaluation for handover may include comparing a first measurement (e.g., intra-frequency measurement) of a signal from the serving cell of the first subscriber with a second measurement of a signal from a neighboring cell. Each of the measurements may include Srxlev, SINR, RSRP, RSRQ, and/or another measurement of signal strength or quality. In this example, the criteria for handover may be met when the second measurement is greater than the first measurement by at least an offset. In this case, the second measurement being greater than the first measurement by at least the offset may indicate that a handover to the neighboring cell may improve signal strength and/or quality.

In certain aspects, the evaluation for a potential frequency reselection for the first subscriber may include determining whether one or more measurements for the first subscriber meet (i.e., satisfy) a criteria for frequency reselection. If the criteria for frequency reselection is met, then the processor 220 may send a report of the one or more measurements to the network via the transceiver 230. The report may indicate that the criteria for frequency reselection is met. In response, the network may initiate frequency reselection of the first subscriber. In this case, the first subscriber may be taken out of the sleep mode to complete the frequency reselection. If the criteria is not met, then the first subscriber may remain in the sleep mode.

In one example, the evaluation for frequency reselection may include comparing an inter-frequency measurement of a signal from the serving cell of the first subscriber or a neighboring cell with a threshold. The measurement may include Srxlev, SINR, RSRP, RSRQ, and/or another measurement of signal strength or quality. In this example, the criteria for frequency reselection is met when the inter-frequency measurement is above the threshold. In this case, the frequency reselection may include reassigning the first subscriber to the frequency corresponding to the inter-frequency measurement.

In another example, the evaluation for frequency reselection may include comparing an intra-frequency measurement of a signal from the serving cell of the first subscriber with a first threshold and comparing an inter-frequency measurement of a signal from the serving cell or a neighboring cell with a second threshold. Each of the measurements may include Srxlev, SINR, RSRP, RSRQ, and/or another measurement of signal strength or quality. In this example, the criteria for reselection is met when the intra-frequency measurement is below the first threshold and the inter-frequency measurement is above the second threshold. In this case, the frequency reselection may include reassigning the first subscriber to the frequency corresponding to the inter-frequency measurement.

In another example, the evaluation for frequency reselection may include comparing an intra-frequency measurement of a signal from the serving cell of the first subscriber with an inter-frequency measurement of a signal from the serving cell or a neighboring cell. Each of the measurements may include Srxlev, SINR, RSRP, RSRQ, and/or another measurement of signal strength or quality. In this example, the criteria for frequency reselection may be met when the inter-frequency measurement is greater than the intra-frequency measurement by at least an offset. In this case, the frequency reselection may include reassigning the first subscriber to the frequency corresponding to the inter-frequency measurement.

In certain aspects, the evaluation for switching the first subscriber to another RAT may include determining whether one or more measurements for the first subscriber meet (i.e., satisfy) a criteria for switching the RAT. If the criteria is met, then the processor 220 may send a report of the one or more measurements to the network via the transceiver 230. The report may indicate that the criteria for switching the RAT of the first subscriber is met. In response, the network may switch the first subscriber to the other RAT. In this case, the first subscriber may be taken out of the sleep mode to complete the switch to the other RAT. If the criteria is not met, then the first subscriber may remain in the sleep mode.

In one example, the evaluation for switching the RAT of the first subscriber may include comparing an IRAT measurement with a threshold. The IRAT measurement may include Srxlev, SINR, RSRP, RSRQ, and/or another measurement of signal strength or quality. In this example, the criteria for switching the RAT of the subscriber is met when the IRAT measurement is above the threshold. In this case, the first subscriber may be switched to the RAT corresponding to the IRAT measurement when the criteria is met.

In another example, the evaluation for switching the RAT of the first subscriber may include comparing a measurement for a first RAT currently assigned to the first subscriber with a first threshold and comparing an IRAT measurement for a second RAT with a second threshold. Each of the measurements may include Srxlev, SINR, RSRP, RSRQ, and/or another measurement of signal strength or quality. In this example, the criteria for switching the RAT is met when measurement for the first RAT is below the first threshold and the IRAT measurement for the second RAT is above the second threshold. In this case, the first subscriber may be switched to the second RAT when the criteria is met.

In another example, the evaluation for switching the RAT of the first subscriber may include comparing a measurement for a first RAT currently assigned to the first subscriber with an IRAT measurement for a second RAT. Each of the measurements may include Srxlev, SINR, RSRP, RSRQ, and/or another measurement of signal strength or quality. In this example, the criteria for switching the RAT is met when the IRAT measurement for the second RAT is greater than the measurement for the first RAT by at least an offset. In this case, the first subscriber may be switched to the second RAT when the criteria is met.

It is to be appreciated that the processor 220 may also evaluate the measurements for the second subscriber using any one or more of the criteria discussed above to determine whether a handover, a frequency reselection, and/or a RAT switch is needed for the second subscriber.

It is also to be appreciated that the present disclosure is not limited to the case where the second subscriber has ownership of the TRM resource. For example, when the first subscriber has ownership of the TRM resource during a time duration (e.g., DRX cycle), the UE 215 may perform measurements for the first subscriber and the second subscriber while the second subscriber is in the sleep mode. The processor 220 may then evaluate measurements for the second subscriber using any one or more of the criteria discussed above to determine whether a handover, a frequency reselection, and/or a RAT switch is needed for the second subscriber.

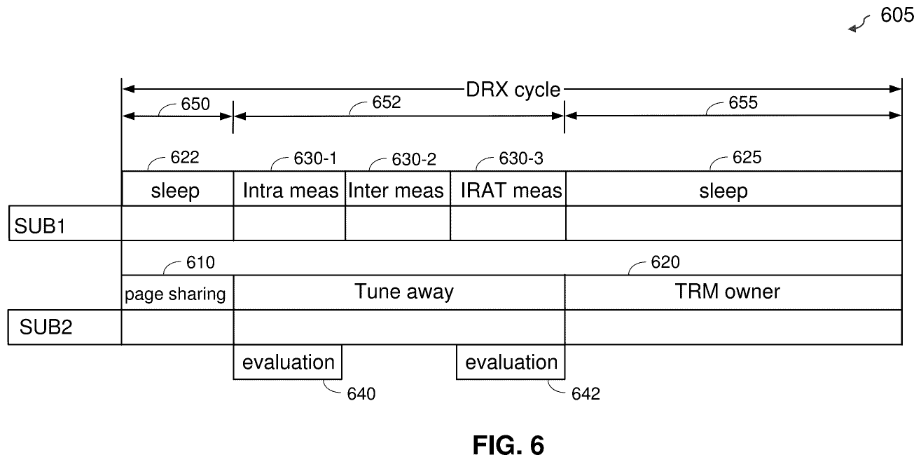

FIG. 6 shows another example in which the first subscriber and the second subscriber take turns having ownership of the TRM resource during a DRX cycle (e.g., in a MSMA mode). In this example, DRX cycle includes a first time duration 650, a second time duration 652, and a third duration 655.

In this example, the first time duration 650 is used for page sharing 610 in which the second subscriber receives paging messages via the transceiver 230 for the first subscriber and/or the second subscriber from a cell (e.g., the serving cell of the second subscriber). The first subscriber is in the sleep mode during the first time duration 650.

During the second time duration 652, the first subscriber has ownership of the TRM resource for performing measurements. While the first subscriber has ownership of the TRM resource, the UE 215 performs measurements (e.g., intra-frequency measurements, inter-frequency measurements, and/or IRAT measurements) for the first subscriber as well as the second subscriber. The resulting measurements for the first subscriber and the second subscriber may be stored in the common (i.e., shared) memory (e.g., memory 240), discussed above with respect to FIG. 5. As discussed above, the measurements for the first subscriber and the second subscriber may overlap (i.e., one or more of the measurements may be used for making a handover decision and/or frequency reselection for either of the subscribers).

The processor 220 may evaluate measurements for the second subscriber using any one or more of the criteria discussed above to determine whether a handover, a frequency reselection, and/or a RAT switch is needed for the second subscriber. The processor 220 may also evaluate the measurements for the first subscriber using any one or more of the criteria discussed above to determine whether a handover, a frequency reselection, and/or a RAT switch is needed for the first subscriber. As shown in FIG. 6, the evaluations 640 and 642 for the first subscriber and/or the second subscriber may be performed during the second time duration 652.

During the third time duration 655, the second subscriber has ownership of the TRM resource 620. For example, the second subscriber may have ownership of the TRM resource 620 for a service connection with the network (e.g., a connection for data service, voice call service, etc.). Also, during the third duration 655, the first subscriber reenters the sleep mode 625.

Thus, in this example, the first subscriber and the second subscriber take turns having ownership of the TRM resource during the DRX cycle. The first subscriber takes ownership of the TRM resource during the second time duration 652 for performing measurements for the first subscriber and the second subscriber, and the second subscriber takes ownership of the TRM resource during the third time duration 655 for a service connection (e.g., to receive data services, voice call services, etc.).

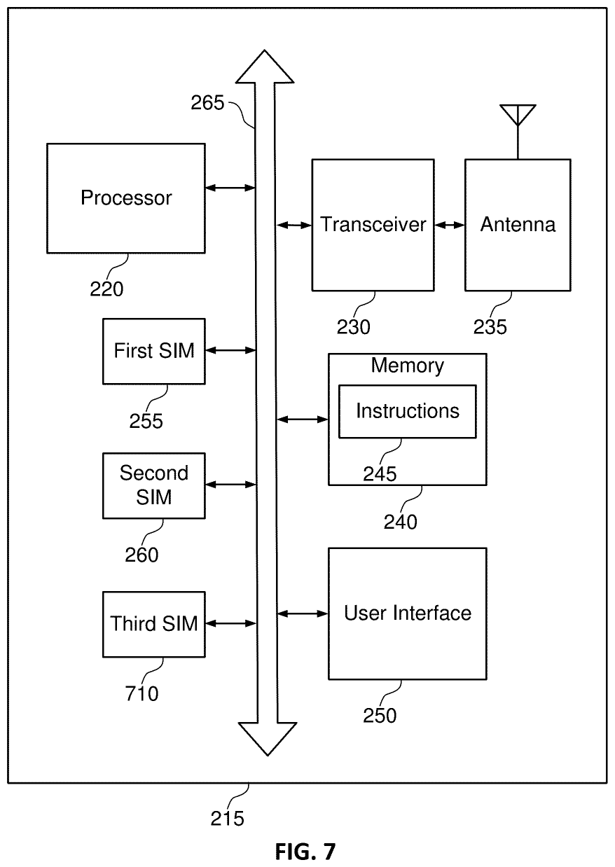

It is to be appreciated that aspects of the present disclosure discussed above may be extended to three or more SIMs. In this regard, FIG. 7 shows an example in which the UE 215 further includes a third SIM 710 corresponding to a third subscriber. The third SIM 710 may be coupled to one or more of the other components of the UE 215 via the one or more buses 265.

The third SIM 710 includes memory (e.g., in a removable integrated circuit card) that stores an International Mobile Subscriber Identity (IMSI), user account information, authentication information, and/or other information used to identify and/or authenticate the third subscriber with a network (e.g., wireless communications system 100). The third subscriber may have a subscription for one or more services (e.g., data services, voice services, IMS services, etc.) on the network. Although three SIMs (i.e., the first SIM 225, the second SIM 260, and the third SIM 710) are shown in FIG. 7, it is to be appreciated that the UE 215 may include more than three SIMs in some implementations.

In this example, the first subscriber, the second subscriber, and the third subscriber share the transceiver 230, in which the transceiver 230 provides the TRM resource on the UE 215 for the subscribers. In this example, the first subscriber, the second subscriber, and the third subscriber share the TRM resource (i.e., transceiver 230) in which the UE 215 grants one of the first subscriber, the second subscriber, and the third subscriber ownership of the TRM resource at a time. For example, the UE 215 may grant one of the first subscriber, the second subscriber, and the third subscriber ownership of the TRM resource at a time for an active service connection with a network (e.g., wireless communications system 100).

In this example, the UE 215 may grant the second subscriber ownership of the TRM resource during the time duration 408 (e.g., DRX cycle) shown in FIG. 4. For example, the second subscriber may receive a voice call from the network, and the UE 215 may grant ownership of the TRM resource (i.e., access to the transceiver 230) to the second subscriber to receive the voice call. However, it is to be appreciated that the present disclosure is not limited to this example, and that the UE 215 may grant the second subscriber ownership of the TRM resource during the time duration 408 in another use case. During the time duration 408 (e.g., DRX cycle), the first subscriber and the third subscriber do not have access to the TRM resource in this example.

In this example, the second subscriber has ownership of the TRM resource 415 during the time duration 408 (e.g., for a service connection with the network). For the example of a data service, the second subscriber may receive data from and/or transmit data to the network via the transceiver 230. For the example of a voice call service, the second subscriber may make or receive a voice call.

While the second subscriber has ownership of the TRM resource, the UE 215 performs measurements (e.g., intra-frequency measurements, inter-frequency measurements, and/or IRAT measurements) for the second subscriber as well as the first subscriber and the third subscriber. This allows the first subscriber and the third subscriber to both remain in the sleep mode for the time duration 408 while still obtaining the measurements needed to make handover decisions and/or frequency reselection decisions for the first subscriber and the third subscriber. The measurements obtained for the first subscriber and the third subscriber may be stored in the common memory (e.g., memory 240) and evaluated by the processor 220 for handover and/or frequency reselection of the first subscriber and/or the third subscriber. For example, the processor 220 may evaluate measurements for the first subscriber using any one or more of the criteria discussed above to determine whether a handover, a frequency reselection, and/or a RAT switch is needed for the first subscriber. Similarly, the processor 220 may evaluate the measurements for the third subscriber using any one or more of the criteria discussed above to determine whether a handover, a frequency reselection, and/or a RAT switch is needed for the third subscriber.

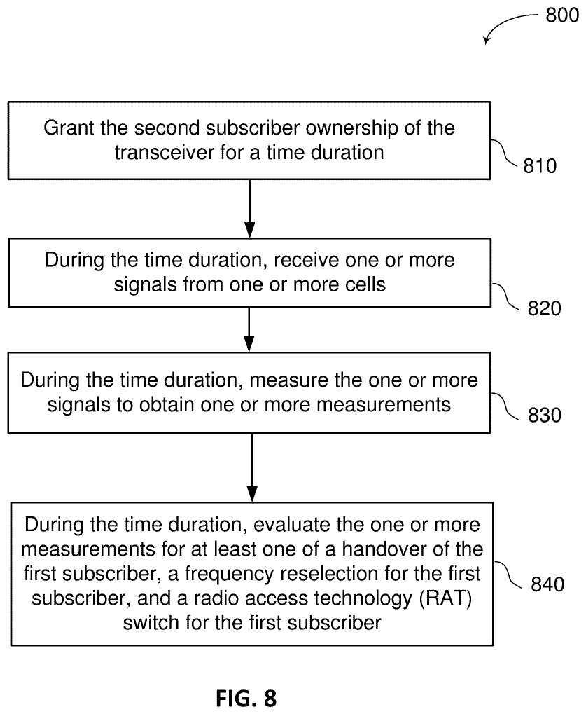

FIG. 8 illustrates a method 800 of operating a wireless device (e.g., UE 215) according to certain aspects. The wireless device includes a first subscriber identity module (SIM) (e.g., first SIM 255) corresponding to a first subscriber, a second SIM (e.g., second SIM 260) corresponding to a second subscriber, and a transceiver (e.g., transceiver 230) shared by the first subscriber and the second subscriber. It is to be appreciated that the wireless device may also include one or more additional SIMs (e.g., third SIM 710) corresponding to one or more additional subscribers in some implementations.

At block 810, the second subscriber is granted ownership of the transceiver for a time duration. The time duration may correspond to time duration 408 and may include a DRX cycle. In certain aspects, the first subscriber is put in sleep mode during the time duration.

At block 820, during the time duration, one or more signals are received from one or more cells via the transceiver. For example, the one or more cells may include a serving cell and one or more neighboring cells.

At block 830, during the time duration, the one or more signals are measured to obtain one or more measurements. For example, the one or more measurements may include at least one of one or more intra-frequency measurements, one or more inter-frequency measurements, and one or more inter-radio access technology (IRAT) measurements.

At block 840, during the time duration, the one or more measurements are evaluated for at least one of a handover of the first subscriber, a frequency reselection for the first subscriber, and a radio access technology (RAT) switch for the first subscriber. In certain aspects, the evaluation includes determining whether the one or more measurements satisfy at least one of a handover criteria, a frequency reselection criteria, and a RAT switch criteria for RAT.

In certain aspects, the wireless device may further include a third SIM (e.g., third SIM 710) corresponding to a third subscriber. In these aspects, during the time duration (e.g., DRX cycle), the one or more measurements may also be evaluated for at least one of a handover of the third subscriber, a frequency reselection for the third subscriber, and a RAT switch for the third subscriber. In certain aspects, the evaluation for the third subscriber may include determining whether the one or more measurements satisfy at least one of a handover criteria, a frequency reselection criteria, and a RAT switch criteria for RAT. It is to be appreciated that the method 800 may be further extended to a wireless device including four or more SIMs corresponding to four or more subscriber in a similar manner.

Implementation examples are described in the following numbered clauses:
1. An apparatus for wireless communication, comprising:
   a first subscriber identity module (SIM) corresponding to a first subscriber;
   a second SIM corresponding to a second subscriber;
   a transceiver that is shared by the first subscriber and the second subscriber;
   a processor;
   a memory coupled with the processor; and
   instructions stored in the memory and executable by the processor to cause the apparatus to:
   grant the second subscriber ownership of the transceiver for a time duration;
   during the time duration, receive one or more signals from one or more cells via the transceiver;
   during the time duration, measure the one or more signals to obtain one or more measurements; and
   during the time duration, evaluate the one or more measurements for at least one of a handover of the first subscriber, a frequency reselection for the first subscriber, and a radio access technology (RAT) switch for the first subscriber.
2. The apparatus of clause 1, wherein the time duration includes a discontinuous reception (DRX) cycle.
3. The apparatus of clause 1 or 2, further comprising instructions stored in the memory and executable by the processor to cause the apparatus to put the first subscriber in a sleep mode during the time duration.
4. The apparatus of any one of clauses 1 to 3, further comprising instructions stored in the memory and executable by the processor to cause the apparatus to establish a service connection for the second subscriber during the time duration.
5. The apparatus of clause 4, wherein the service connection includes at least one of a data service connection and a voice call service connection.
6. The apparatus of any one of clauses 1 to 5, further comprising instructions stored in the memory and executable by the processor to cause the apparatus to, during the time duration, evaluate the one or more measurements for at least one of a handover of the second subscriber, a frequency reselection for the second subscriber, and a RAT switch for the second subscriber.
7. The apparatus of any one of clauses 1 to 6, wherein the one or more measurements include at least one of one or more intra-frequency measurements, one or more inter-frequency measurements, and one or more inter-radio access technology (IRAT) measurements.
8. The apparatus of any one of clauses 1 to 8, wherein the instructions to evaluate the one or more measurements include instructions executable by the processor to cause the apparatus to determine whether the one or more measurements satisfy at least one of a handover criteria, a frequency reselection criteria, and a RAT switch criteria for RAT.
9. The apparatus of clause 8, further comprising instructions stored in the memory and executable by the processor to cause the apparatus to, if the handover criteria is satisfied, transmit a report to at least one of the one or more cells via the transceiver, the report indicating that the handover criteria is satisfied.
10. The apparatus of clause 8, further comprising instructions stored in the memory and executable by the processor to cause the apparatus to, if the frequency reselection criteria is satisfied, transmit a report to at least one of the one or more cells via the transceiver, the report indicating that the frequency reselection criteria is satisfied.
11. The apparatus of clause 8, further comprising instructions stored in the memory and executable by the processor to cause the apparatus to, if the RAT switch criteria is satisfied, transmit a report to at least one of the one or more cells via the transceiver, the report indicating that the RAT switch criteria is satisfied.
12. The apparatus of any one of clauses 1 to 11, further comprising:
   a third SIM corresponding to a third subscriber; and
   instructions stored in the memory and executable by the processor to cause the apparatus to, during the time duration, evaluate the one or more measurements for at least one of a handover of the third subscriber, a frequency reselection for the third subscriber, and a radio access technology (RAT) switch for the third subscriber.
13. The apparatus of clause 12, further comprising instructions stored in the memory and executable by the processor to cause the apparatus to put the first subscriber and the third subscriber in a sleep mode during the time duration.
14. A method of operating a wireless device, the wireless device including a first subscriber identity module (SIM) corresponding to a first subscriber, a second SIM corresponding to a second subscriber, and a transceiver shared by the first subscriber and the second subscriber, the method comprising:
   granting the second subscriber ownership of the transceiver for a time duration;
   during the time duration, receiving one or more signals from one or more cells via the transceiver;
   during the time duration, measuring the one or more signals to obtain one or more measurements; and
   during the time duration, evaluating the one or more measurements for at least one of a handover of the first subscriber, a frequency reselection for the first subscriber, and a radio access technology (RAT) switch for the first subscriber.
15. The method of clause 14, wherein the time duration includes a discontinuous reception (DRX) cycle.
16. The method of clause 14 or 15, further comprising putting the first subscriber in a sleep mode during the time duration.
17. The method of any one of clauses 14 to 16, further comprising establishing a service connection for the second subscriber during the time duration.
18. The method of clause 17, wherein the service connection includes at least one of a data service connection and a voice call service connection.
19. The method of any one of clauses 14 to 18, further comprising, during the time duration, evaluating the one or more measurements for at least one of a handover of the second subscriber, a frequency reselection for the second subscriber, and a RAT switch for the second subscriber.
20. The method of any one of clauses 14 to 19, wherein the one or more measurements include at least one of one or more intra-frequency measurements, one or more inter-frequency measurements, and one or more inter-radio access technology (IRAT) measurements.
21. The method of any one of clauses 14 to 20, wherein evaluating the one or more measurements comprises determining whether the one or more measurements satisfy at least one of a handover criteria, a frequency reselection criteria, and a RAT switch criteria for RAT.
22. The method of clause 21, further comprising, if the handover criteria is satisfied, transmitting a report to at least one of the one or more cells via the transceiver, the report indicating that the handover criteria is satisfied.
23. The method of clause 21, further comprising, if the frequency reselection criteria is satisfied, transmitting a report to at least one of the one or more cells via the transceiver, the report indicating that the frequency reselection criteria is satisfied.
24. The method of clause 21, further comprising, if the RAT switch criteria is satisfied, transmitting a report to at least one of the one or more cells via the transceiver, the report indicating that the RAT switch criteria is satisfied.
25. The method of any one of clauses 14 to 24, wherein:
   the wireless device also includes a third SIM corresponding to a third subscriber; and
   the method further comprises, during the time duration, evaluating the one or more measurements for at least one of a handover of the third subscriber, a frequency reselection for the third subscriber, and a RAT switch for the third subscriber.
26. The method of clause 25, further comprising putting the first subscriber and the third subscriber in a sleep mode during the time duration.

Any reference to an element herein using a designation such as “first,” “second,” and so forth does not generally limit the quantity or order of those elements. Rather, these designations are used herein as a convenient way of distinguishing between two or more elements or instances of an element. Thus, a reference to first and second elements does not mean that only two elements can be employed, or that the first element must precede the second element.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect electrical coupling between two structures. As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

1. An apparatus for wireless communication, comprising:
a first subscriber identity module (SIM) corresponding to a first subscriber;
a second SIM corresponding to a second subscriber;
a transceiver that is shared by the first subscriber and the second subscriber;
a processor;
a memory coupled with the processor; and
instructions stored in the memory and executable by the processor to cause the apparatus to:
grant the second subscriber ownership of the transceiver for a time duration;
during the time duration, receive one or more signals from one or more cells via the transceiver;
during the time duration, measure the one or more signals to obtain one or more measurements; and
during the time duration, evaluate the one or more measurements for at least one of a handover of the first subscriber, a frequency reselection for the first subscriber, and a radio access technology (RAT) switch for the first subscriber.

2. The apparatus of claim 1, wherein the time duration includes a discontinuous reception (DRX) cycle.

3. The apparatus of claim 1, further comprising instructions stored in the memory and executable by the processor to cause the apparatus to put the first subscriber in a sleep mode during the time duration.

4. The apparatus of claim 1, further comprising instructions stored in the memory and executable by the processor to cause the apparatus to establish a service connection for the second subscriber during the time duration.

5. The apparatus of claim 4, wherein the service connection includes at least one of a data service connection and a voice call service connection.

6. The apparatus of claim 1, further comprising instructions stored in the memory and executable by the processor to cause the apparatus to, during the time duration, evaluate the one or more measurements for at least one of a handover of the second subscriber, a frequency reselection for the second subscriber, and a RAT switch for the second subscriber.

7. The apparatus of claim 1, wherein the one or more measurements include at least one of one or more intra-frequency measurements, one or more inter-frequency measurements, and one or more inter-radio access technology (IRAT) measurements.

8. The apparatus of claim 1, wherein the instructions to evaluate the one or more measurements include instructions executable by the processor to cause the apparatus to determine whether the one or more measurements satisfy at least one of a handover criteria, a frequency reselection criteria, and a RAT switch criteria for RAT.

9. The apparatus of claim 8, further comprising instructions stored in the memory and executable by the processor to cause the apparatus to, if the handover criteria is satisfied, transmit a report to at least one of the one or more cells via the transceiver, the report indicating that the handover criteria is satisfied.

10. The apparatus of claim 8, further comprising instructions stored in the memory and executable by the processor to cause the apparatus to, if the frequency reselection criteria is satisfied, transmit a report to at least one of the one or more cells via the transceiver, the report indicating that the frequency reselection criteria is satisfied.

11. The apparatus of claim 8, further comprising instructions stored in the memory and executable by the processor to cause the apparatus to, if the RAT switch criteria is satisfied, transmit a report to at least one of the one or more cells via the transceiver, the report indicating that the RAT switch criteria is satisfied.

12. The apparatus of claim 1, further comprising:
a third SIM corresponding to a third subscriber; and
instructions stored in the memory and executable by the processor to cause the apparatus to, during the time duration, evaluate the one or more measurements for at least one of a handover of the third subscriber, a frequency reselection for the third subscriber, and a radio access technology (RAT) switch for the third subscriber.

13. The apparatus of claim 12, further comprising instructions stored in the memory and executable by the processor to cause the apparatus to put the first subscriber and the third subscriber in a sleep mode during the time duration.

14. A method of operating a wireless device, the wireless device including a first subscriber identity module (SIM) corresponding to a first subscriber, a second SIM corresponding to a second subscriber, and a transceiver shared by the first subscriber and the second subscriber, the method comprising:
granting the second subscriber ownership of the transceiver for a time duration;
during the time duration, receiving one or more signals from one or more cells via the transceiver;
during the time duration, measuring the one or more signals to obtain one or more measurements; and
during the time duration, evaluating the one or more measurements for at least one of a handover of the first subscriber, a frequency reselection for the first subscriber, and a radio access technology (RAT) switch for the first subscriber.

15. The method of claim 14, wherein the time duration includes a discontinuous reception (DRX) cycle.

16. The method of claim 14, further comprising putting the first subscriber in a sleep mode during the time duration.

17. The method of claim 14, further comprising establishing a service connection for the second subscriber during the time duration.

18. The method of claim 17, wherein the service connection includes at least one of a data service connection and a voice call service connection.

19. The method of claim 14, further comprising, during the time duration, evaluating the one or more measurements for at least one of a handover of the second subscriber, a frequency reselection for the second subscriber, and a RAT switch for the second subscriber.

20. The method of claim 14, wherein the one or more measurements include at least one of one or more intra-frequency measurements, one or more inter-frequency measurements, and one or more inter-radio access technology (IRAT) measurements.

21. The method of claim 14, wherein evaluating the one or more measurements comprises determining whether the one or more measurements satisfy at least one of a handover criteria, a frequency reselection criteria, and a RAT switch criteria for RAT.

22. The method of claim 21, further comprising, if the handover criteria is satisfied, transmitting a report to at least one of the one or more cells via the transceiver, the report indicating that the handover criteria is satisfied.

23. The method of claim 21, further comprising, if the frequency reselection criteria is satisfied, transmitting a report to at least one of the one or more cells via the transceiver, the report indicating that the frequency reselection criteria is satisfied.

24. The method of claim 21, further comprising, if the RAT switch criteria is satisfied, transmitting a report to at least one of the one or more cells via the transceiver, the report indicating that the RAT switch criteria is satisfied.

25. The method of claim 14, wherein:
the wireless device also includes a third SIM corresponding to a third subscriber; and
the method further comprises, during the time duration, evaluating the one or more measurements for at least one of a handover of the third subscriber, a frequency reselection for the third subscriber, and a RAT switch for the third subscriber.

26. The method of claim 25, further comprising putting the first subscriber and the third subscriber in a sleep mode during the time duration.
